(19) United States
(12) Patent Application Publication
(10) Pub. No.: US 2009/0212514 A1
(43) Pub. Date: Aug. 27, 2009

(54) Creeper dolly

(76) Inventor: Adrian Scott Moorman, JR., Louisville, KY (US)

Correspondence Address: Adrian S. Moorman Jr., 1627 Longfield Ave., Louisville, KY, 40215, US

(21) Appl. No.: 12/008,971

(22) Filed: Feb. 25, 2008

(51) Int. Cl. B25H 5/00

(52) U.S. Cl. 280/32.6

(57) ABSTRACT

The Creeper Dolly is for the use of moving heavy objects by placing them on Creeper Dolly and wheeling it to the desired location. The invention could also be used as a creeper to allow an individual to freely slide underneath a vehicle or into confine areas while working and performing various task. Made of two major components, the wheel base and resting board, the Creeper Dolly is able to adjust to accommodate various size objects or individuals by expanding the landing area in which the object or individual would rest upon. By extending and retracting the wheel base's lattice style structure in a scissor like manner, the wheel base could increase and shorten in length. Once the desired length of the wheel base as been reached, the resting board is to be laid on the wheel base to provide a comfortable resting place for an individual or object.

### FIELD OF INVENTION

This invention is directly related to portable wheel dollies to be used for moving and hauling large furniture, equipment and machinery. This invention also relates to portable wheel creepers to be used by mechanics to slide under vehicles, more particularly, to a multifunction invention that could extract to extend in length and retract to be shorten in length to better accommodate an individual moving different size objects, or various size individuals working in confine spaces, such as a mechanic working on under a vehicle.

### DESCRIPTION OF RELATED ART

There are two things the average adult person will have to do at least once in their life. The first thing is move or arrange a heavy object from one place to another. The average person moves or relocates from one residence or geographical area to another at least twice in their life. No matter how small the move, this could be a pain staking task for anyone. The difficulty of moving often involves moving large items such as furniture, equipment, machinery and other large items, possibly causing back injuries to thousands of individuals across the globe. To avoid some of the frustration associated with hauling heavy items, many people simply leave or sell valuable objects for much less than its actual worth.

The moving of heavy objects is not limited to individuals relocating. One would be hard pressed to find a single store, manufacturing plant, warehouse, or office space that does not handle a desk, appliance, equipment, products or an oversized object of some sort. To assist in the moving of these large objects, one may require the use of a wheel dolly.

A wheel dolly is a device with wheels or rollers that is designed to support the weight of a heavy object, allowing an individual to be able to push the object to its destination. The residential and commercial use of wheel dollies is a vital part of maneuvering large heavy objects and has been around for centuries. With the proper use of leverage and wheels, an individual could move an object they normally would not be able to.

A frequent problem a person may encounter with using a traditional wheel dolly is that the dolly may be to small or large for the actual object being moved. If the dolly is to small for the object being moved, the dolly would not provide enough service resting area underneath the object. Therefore, balancing the oversized object on an inadequate landing area would be very difficult. If the dolly is to large, it would be difficult to store, carry and operate, possibly requiring assistance to handle it.

If the dolly is made of a four wheel flat bed with a handle at one end, it would have to be an adequate size to properly accommodate the object. A dolly that is to small would be very limited to the distance it could reach underneath the object being moved. For this reason, wheel dollies come in vast shapes and sizes. The current solution to matching the appropriate dolly to the size of the object being moved, is to purchase a number of dollies in different sizes and switching from one dolly to another as needed. This could be very costly and inefficient as the number and size of the dollies could take up a considerable amount of space.

The second thing this invention addresses is another great need of people from different walks of life. Each year millions of people work in low and confine spaces. All throughout the world, professional and novice laborers are performing various tasks in hard to reach, confine areas. These tasks include working on vehicles, plumbing, furnaces, machinery, houses and many others. Performing these various task may require an individual to assume an number of postures and positions.

If a mechanic is working on a vehicle, he/she may have to lye completely flat to get underneath the vehicle. However, a plumber working under a kitchen sink or an electrician working in a crawl space may need to work in the sitting position. The posture needed to complete a task depends on the task itself, and could vary as much as the number of tasks being performed.

The current solution to this problem is to apply the use of a creeper. A creeper is a device that consists of a flat board of sort with wheels affixed to the bottom of the board. The function of a traditional creeper is to provide means for a person to perform labor in or round-about the confine work area, by lying or sitting on the board and sliding to or under the confine work area. Although the creeper could be used for various assignments, its most popular use is by mechanics working under vehicles.

As with the dolly, the creeper must also be large enough to provide adequate surface area for the individual resting on it. The people using creepers today vary in shape and size. These variations is one of the reason creepers come in different lengths and widths. Another reason for the different size in creepers is their function. Depending on its usage, the creeper must be small enough to maneuver into narrow openings, crawl spaces, between cabinets and more. If an individual was to purchase a creeper that is a standard length, he/she could be limited to using it for its intended purpose only. Therefore, a different creeper would have to be purchased to accomplish different tasks.

### BRIEF SUMMARY OF INVENTION

In view of all the apparent disadvantages of standard wheel dollies, the creeper dolly provides a solution to many of the problems addressed prior. It is an object of this present invention to provide a dolly that accommodates various size items, eliminating the need to purchase a several dollies. The present invention would achieve this by being able to adjust in length and width, therefore, increasing or decreasing the landing surface in which the item would rest.

To resolve many of the problems addressed prior with creepers, the creeper dolly would provide the same extending and retracting capabilities to for an individual to properly rest on the landing surface. Another object of said invention is that it would be provide means to slide into small confine areas by reducing in size. Also, the size reduction would make the present invention portable and easy to maneuver.

Comprised of similar shaped planks made of rigid material, the creeper dolly would be designed in a web like fashion, similar to a lattice structure, with pivotal points at each joining end. The pivoting points at the joining ends would allow each section of said invention to open and close in a scissor like motion. As the planks pivot the ends of said invention moves further apart from each other. The further the ends of said invention moves from each other, the greater the length of said invention becomes. This act is known as the extension of said invention.

The reversal of the extension of said invention is the retraction. During the retraction process, the planks are pushed closer together, therefore bringing the ends of said invention closer together, causing the creeper dolly to reduce in length.

### BRIEF DESCRIPTION OF SEVERAL VIEWS OF DRAWINGS

A fuller understanding of the nature and objects of the present invention will become apparent upon consideration of the following detailed description taken in connection with the accompanying drawings, wherein:

FIG. 1 is a perspective view of a lattice structure creeper dolly fully retracted;

FIG. 2 is a perspective view of the lattice structure creeper dolly of FIG. 1 fully extended;

FIG. 3 is a perspective view of a foldable platform;

FIG. 4 is perspective view of the foldable platform of FIG. 3 completely folded and fixed on top of the completely retracted lattice structure of FIG. 1;

FIG. 5 is a view of the foldable platform of FIG. 3 partial folded and fixed on top of the fully extended lattice structure of FIG. 2;

FIG. 6 is a view of said resting board of FIG. 3 completely unfolded and fixed on top of the fully extended lattice structure of FIG. 2;

FIG. 7 is a bottom view of said resting board of FIG. 3 completely unfolded and fixed on top of the fully extended lattice structure of FIG. 2;

### DETAILED DESCRIPTION OF YOUR INVENTION

The creeper dolly is a tool with a multifunction purpose that could be used as a creeper or a wheel dolly. Used as a creeper, the invention could provide support, by means of supporting the body, to an individual when working under a vehicle or in confine areas. When used as a dolly, the invention would be used to support the weight of an object for moving the object.

Unlike most creepers and dollies, the adjustable top surface, the area which the object or individual would rest upon, of the invention is able to be adjusted to accommodate various size objects and individuals in which it is supporting. The creeper dolly is comprised of strategically placed planks fastened together to form a lattice structure.

The planks a held in placed with pivot pins, positioned at the end of each plank. The planks are able to swivel upon the axis of the pivot pins to provide range of motion for the lattice structure. As the planks pivot in a scissor like motion on the pivot pins, the entire lattice structure moves in an accordion like fashion, causing the present invention to extend and retract in length.

This extension and retraction of the creeper dolly allows an individual to lengthen or shorten the present invention as needed. These adjustments will allow an individual to reduce the size of the present invention to be used in a work area with limited space. The present invention could also be extended to provide a longer resting area to a person performing a task while laying down.

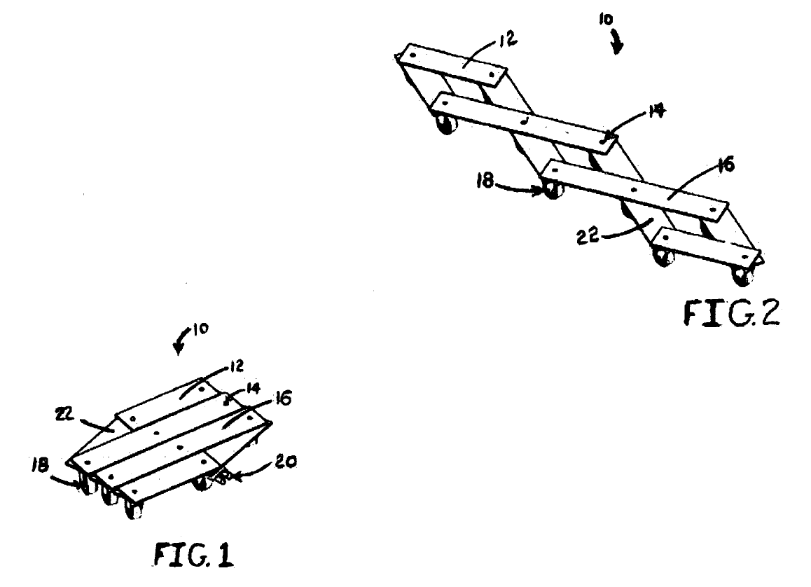

Referring now to the drawings, in FIGS. 1, 2 there as shown a lattice structure (10) of the creeper dolly comprised of short planks (12) and long planks (16) assembled to in a manner to form a lattice structure (10). The adjustable top surface of the lattice structure (10) is comprise of short planks (12) and long planks (16).

The short planks (12) and long planks (16) in FIG. 1 placed tightly together form a closed solid resting surface of the adjustable top surface for the creeper dolly. The short planks (12) and long planks (16) in FIG. 2 placed apart form a open solid resting surface of the adjustable top surface.

The bottom portion of the lattice structure (10) comprise of under planks (22). The short planks (12) and long planks (16) of the lattice structure (10) are affixed to the under planks (22) of the lattice structure (10) in an criss cross (X) fashion, by means of pivot pins (14) at the ends of short planks (12), long planks (16) and under planks (22). Short planks (12) are shorter in length than longer planks, requiring one additional pivot pin (14) to adjoin the long plank (16) to the long under plank (22) in the center of the long plank (16) and under plank (22).

Under planks are attached to short planks (12) and long planks (16) by means of pivot pins (14), permitting under planks (22), short planks (12) and long planks (16) to freely pivot or swivel at the axis of each pivot pin (14), increasing the distance between each short plank and long plank (16), exposing more of the under plank (22). The length of the adjustable top surface of the lattice structure (10) is greater in FIG. 2 when the space between the short planks (12) and long planks (16) is greater. The length of the adjustable top surface of the lattice structure (10) is less in FIG. 1 when the space between the short planks (12) and long planks (16) is less.

Attached to the under planks (22) at one end of the lattice structure (10) is the handle bracket (20). The handle bracket (20) is fastened to the end of a short under plank (22) and protrudes out from the side of the lattice structure (10) for clearance, to permit the attachment of a handle (34) without obstruction from the lattice structure (10).

The base of each pivot pin (14) is attached to a wheel (18), mounted at the bottom of each under plank (22) of the lattice structure (10). Pivot pins (14) fastens to each wheel (18) and secures the wheel (18) firmly in position to the bottom of the under planks (22). The wheels (18) are strategically placed at the end of each under plank (22), short plank and long plank (16), with a wheel (18) in the center of each long plank (16) and the longer under planks (22). The distance between each wheel (18) in FIG. 2 is further apart, the greater the length of the adjustable top surface of the lattice structure (10). The distance between each wheel (18) in FIG. 1 is closer, the shorter the length of the adjustable top surface of the lattice structure (10).

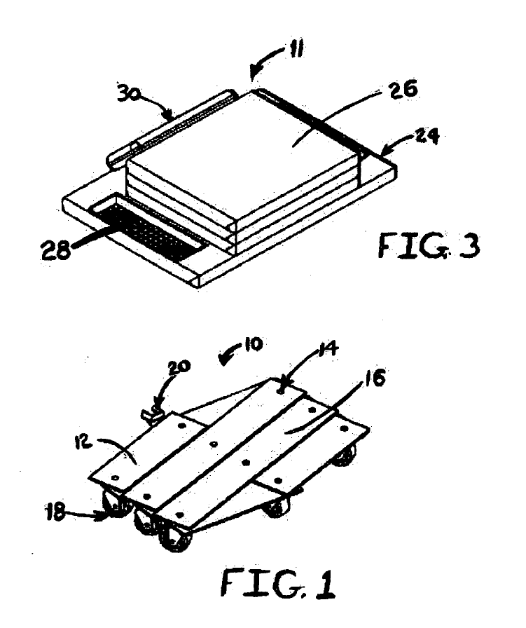

Referring now to the drawings in FIGS. 3, 4, 5 there as shown as the resting board (11) of the creeper dolly comprises of a single resting board platform (24) as the base structure, attached to a foldable platform (26), made up of individual sections connected by hinges.

The resting board platform (24) has two indentations in the top surface at the outer end of both sides known as the platform holding compartments (28). In the center of the two platform holding compartments (28), the foldable platform (26) is attached by means of hinges to the resting board platform (24), to permit the foldable platform (26) to fold on and off of the resting board platform (24), stacking each section of the foldable platform (26) vertically on top of the resting board platform (24).

On the opposite end in which the foldable platform (26) is attached to the resting board platform (24) is a headrest (30), also attached to the resting board platform (24) by hinges, permitting the headrest (30) to fold on and off the resting board platform (24). Said headrest (30) has a headrest storage compartment (32) on the underside.

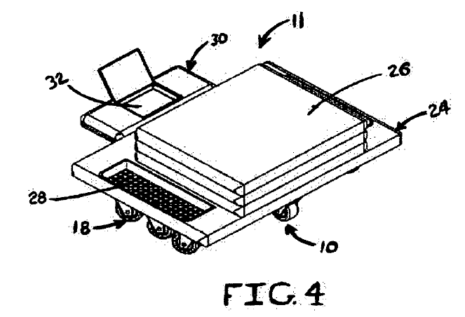

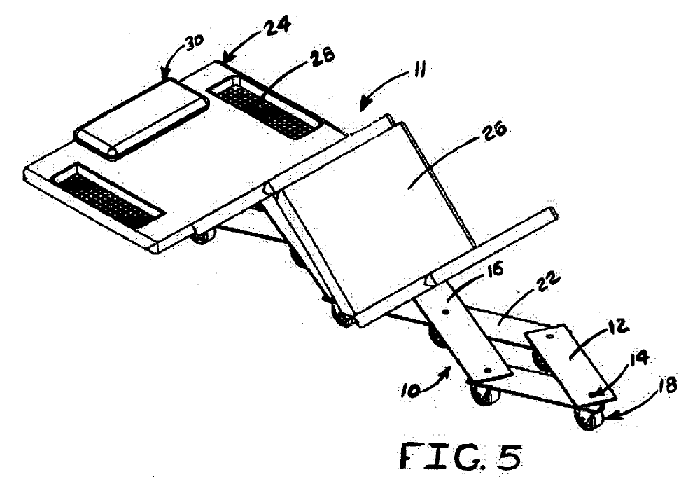

The resting board (11) sits on and is secured to the adjustable top surface of the lattice structure (10) and the headrest (30) is flipped off of the resting board platform (24) in FIG. 4, providing mobility to the resting board (11) by means of the wheels (18) attached to the undercarriage of the lattice structure (10). The foldable platform (26) is completely folded and the lattice structure (10) is completely retracted in FIG. 4. As shown in FIG. 5 the foldable platform (26) is partially unfolded, the lattice structure (10) is completely extended and the headrest (30) is placed on the resting board platform (24).

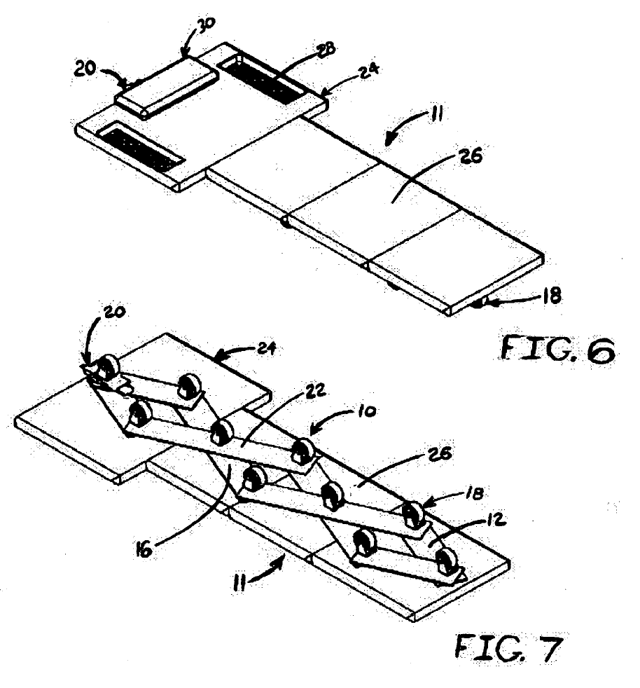

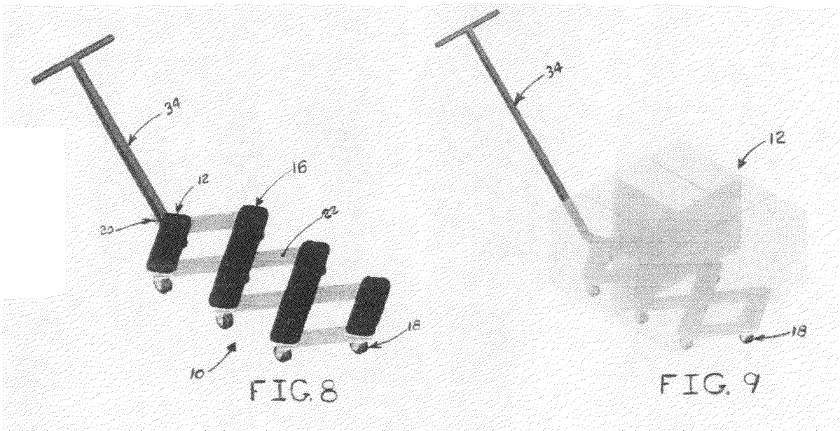

Referring now to the drawings in FIGS. 6, 7 there as shown as the resting board (11) of the creeper dolly with the foldable platform (26) completely unfolded, the lattice structure (10) completely extended and the headrest (30) flipped on top of the resting board platform (24).

The bottom view the resting board (11) and the lattice structure (10) in FIG. 7 wherein the resting board (11) is attached to the lattice structure (10), the wheels (18) are attached to under planks (22). As in FIG. 6 the resting board (11) of the creeper dolly has the foldable platform (26) completely unfolded and the lattice structure (10) completely extended.

Since certain changes may be made in the foregoing disclosure without departing from the scope of the invention herein involved, it is intended that all matter contained in the above description and depicted in the accompanying drawings be construed in an illustrative and not in a limiting sense.

What is claimed is:

1. An adjustable creeper, dolly device, comprising:
a lattice Structure.

2. A lattice Structure as claimed in claim 1, wherein straight planks are crossed in such a position to allow said planks to pivot.

3. A lattice Structure as claimed in claim 1, wherein said planks are able to pivot to increase and decrease the length of said Lattice structure.

4. A Lattice structure as claimed in claim 1, wherein there is an adjustable top portion or surface of said lattice Structure.

5. A Lattice structure as claimed in claim 1, wherein wheels are attached to the under carriage of said adjustable top portion or surface of Lattice structure.

6. An adjustable creeper, dolly device, comprising:
a foldable platform structure.

7. A foldable platform structure as claimed in claim 2, wherein said foldable platform structure is able to fold by sections upon itself by means of hinges between each section.

8. A foldable platform structure as claimed in claim 2, wherein said foldable platform structure is able to unfold by sections from upon itself by means of hinges between each section.

9. A foldable platform structure as claimed in claim 2, wherein said foldable platform structure is able to rest upon said Lattice structure.

10. A foldable platform structure as claimed in claim 2, wherein said foldable platform structure is able to be attached and secured to said Lattice structure.

11. An adjustable creeper, dolly device, comprising:
A pole structure.

12. A Pole structure as claimed in claim 3, wherein said Pole structure is able to attach to said Lattice structure.

13. A Pole structure as claimed in claim 3, wherein said Pole structure is able to detach from said Lattice structure.

14. A Pole structure as claimed in claim 3, wherein said Pole structure is able to increase in length.

15. A Pole structure as claimed in claim 3, wherein said Pole structure is a means for pulling and pushing said Lattice structure;
wherein said Lattice structure, said foldable platform structure and said Pole structure are able to adjust in length and collectively or separately provide means for hauling objects or supporting individuals.
